(19) United States
(12) Patent Application Publication
(10) Pub. No.: US 2009/0313833 A1
(43) Pub. Date: Dec. 24, 2009

(54) MATERIAL TRIMMER WITH ILLUMINATED CUT LINE INDICATOR

(75) Inventors: David C. Eby, Madison, WI (US); Bruce C. Kress, Sun Prairie, WI (US); Doug Birkholz, Madison, WI (US); Robert Schofield, Brooklyn, WI (US); Jim Boda, Merrimac, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: FISKARS BRANDS, INC., Madison, WI (US)

(21) Appl. No.: 12/486,105

(22) Filed: Jun. 17, 2009

Related U.S. Application Data
(60) Provisional application No. 61/073,544, filed on Jun. 18, 2008.

(51) Int. Cl. B26D 7/01

(52) U.S. Cl. 30/124

(57) ABSTRACT

A material trimmer for trimming sheet material having a blade slidingly engageable with the sheet material along a cut line and a cut line projector operable to create a cut line indicator indicative of the approximate location of the cut line. The projector provides for a ready and correct orientation of the sheet material within the material trimmer. The projector includes a light bar mounted to the base of the material trimmer. When activated, the light bar creates an illuminated cut line indicator that is projected onto the material being cut. The illuminated cut line indicator illustrates location where the material trimmer will trim the material placed on the base of the material trimmer.

### CROSS-REFERENCE TO RELATED APPLICATION

The present application is based on and claims priority to U.S. Provisional Patent Application Ser. No. 61/073,544 filed on Jun. 18, 2008.

### BACKGROUND OF THE INVENTION

The present disclosure generally relates to the field of devices for cutting sheet material. More specifically, the present disclosure relates to devices for cutting sheet material that includes a projected indicia representative of the cut line for the device.

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Various conventional systems for trimming sheet material are known. However, it is often difficult or time consuming to orientate and align the sheet material in these systems so that the material may be readily cut at the desired location. The inability to correctly and efficiently determine the location of the cut line using a conventional material trimmer may result in substantial waste and inefficiency.

By way of example, one type of conventional paper trimmer provides a relatively long blade rotatably attached to a base. The trimming operation is performed by progressively lowering the blade along the length of the sheet material to be trimmed. However, it is generally difficult to accurately predict the precise location of the cut line prior to cutting the sheet material using such a system. Further, orientation of the material within and operation of such systems pose substantial safety risks. Another conventional material trimming system generally comprises a blade attached to a carriage adapted to slidingly translate on a guide along the length of the sheet material. However, these systems often conceal the sheet material beneath the guide and or a bulky carriage. Again, orientation and alignment of the sheet material within these material trimmers is difficult and or imprecise and reliable detection of the cut line prior to cutting can be difficult to identify.

### SUMMARY OF THE INVENTION

The present disclosure generally relates to a material trimmer that is operable to trim sheets of material positioned within the device. The material trimmer includes a cut line projector that creates a visual indication of the cut line for the material trimmer on the sheets of material prior to trimming. The visual indication of the cut line allows an operator to correctly position the sheet or sheets of material within the material trimmer prior to cutting, thereby reducing waste. In one embodiment of the present disclosure, the material trimmer includes a base having a support surface that receives the sheet material to be trimmed. In one embodiment, the material trimmer includes a cutting assembly that is movable between a raised, loading position and a lowered, cutting position. When the cutting assembly is in the lowered, cutting position, a blade trims the material along a cut line.

In one embodiment, the cut line projector is mounted to the base and positioned above the support surface of the base. The cut line indicator is operable to project an illuminated cut line indicator onto the sheet material when the sheet material is positioned on the support surface. The illuminated cut line indicator indicates the approximate location of the cut line on the material prior to trimming of the material.

In one embodiment of the disclosure, the cut line projector is mounted to the base such that the cut line projector creates the illuminated cut line indicator on the sheet or sheets of material to be cut before use of the cutting assembly. Once the material has been accurately positioned based upon the illuminated cut line indicator, the cutting assembly can be operated and the cutting blade used to trim the sheet material along the cut line.

In one embodiment, the cutting assembly includes a rotary trimmer that is movable along the support surface to create the cut line. The rotary trimmer includes a rotating trimming blade that is mounted to a movable trolley mounted to a support rail.

In one embodiment of the disclosure, the cut line projector includes a light bar including a series of spaced LEDs. Each of the spaced LEDs are operable to project a source of light to create the illuminated cut line indicator.

These and other features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

The drawings illustrate the best mode presently contemplated of carrying out the invention. In the drawings:

FIG. 1 is a top view of a material trimmer including a cut line projector and a cutting assembly;

FIG. 2 is a top view similar to FIG. 1 with the cutting assembly in its raised, loading position;

FIG. 3 is an exploded view of the material trimmer, including the cutting assembly and the cut line projector;

FIG. 4 is a top view of a second embodiment of a material trimmer including the cut line projector and cutting assembly;

FIG. 5 is a magnified view of the cut line projector and cutting assembly;

FIG. 6 is a partial section view illustrating the mounting of both the cut line projector and cutting assembly to a support rail;

FIG. 7 is a section view taken along line 7-7 of FIG. 4;

FIG. 8 is a magnified view taken along line 8-8 of FIG. 7;

FIG. 9 is an end view taken along line 9-9 of FIG. 8;

FIG. 10 is a section view illustrating the light bar constructed in accordance with the present disclosure;

FIG. 11 is a top perspective view of the light bar;

FIG. 12 is an exploded view of the light bar;

FIG. 13 is a cross section view of a second embodiment of the LED light bar;

FIG. 14 is a cross section view of the LED light bar with an alternate configuration of the masking strips;

FIG. 15 is a top view of a third embodiment of a material trimmer including the cut line projector;

FIG. 16 is a fourth embodiment of a material trimmer including the cut line projector;

FIG. 17 is a fifth embodiment of a material trimmer including the cut line projector;

FIG. 18 is a sixth embodiment of a material trimmer including the cut line projector;

FIG. 19 is a seventh embodiment of a material trimmer including a movable material guard with the cut line projector mounted thereupon; and

FIG. 20 is a view similar to FIG. 19 with the material guard in its raised position.

### DETAILED DESCRIPTION OF THE INVENTION

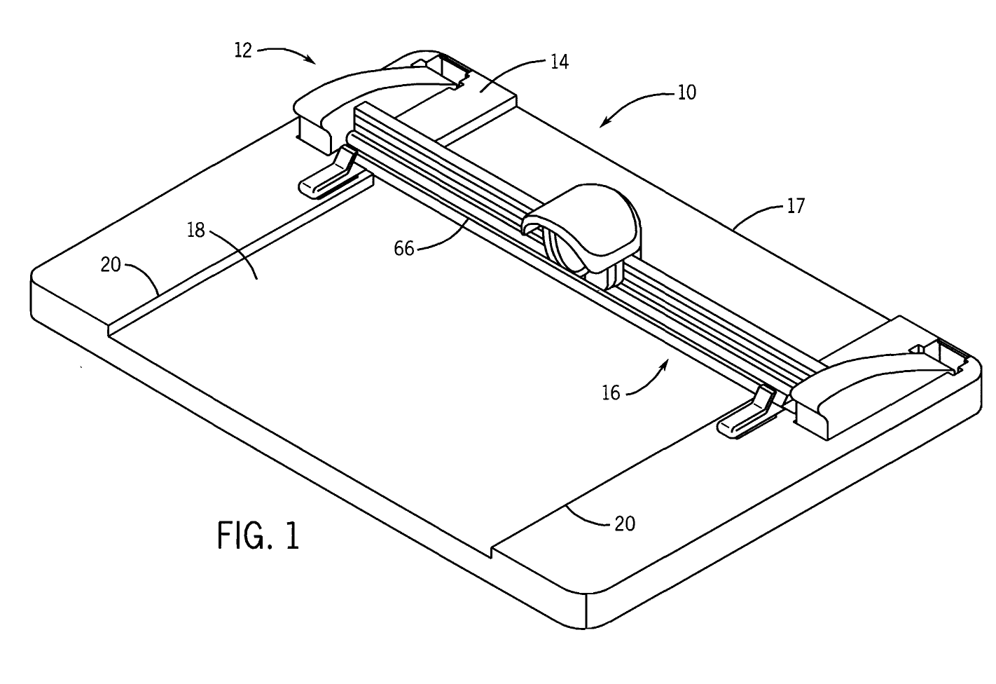

FIG. 1 illustrates a material trimmer 10 constructed in accordance with an embodiment of the present disclosure. The material trimmer 10 includes a cutting assembly 12 pivotally mounted to a base 14. The material trimmer 10 further includes a cut line projector 16 mounted to the base 14.

As illustrated in FIG. 1, the base 14 includes a planar support surface 18 that extends from a first end 17 to a second end 19 between a pair of spaced side edges 20. The side edges 20 are spaced from each other such that the support surface 18 can receive sheets of material to be trimmed utilizing the cutting assembly 12.

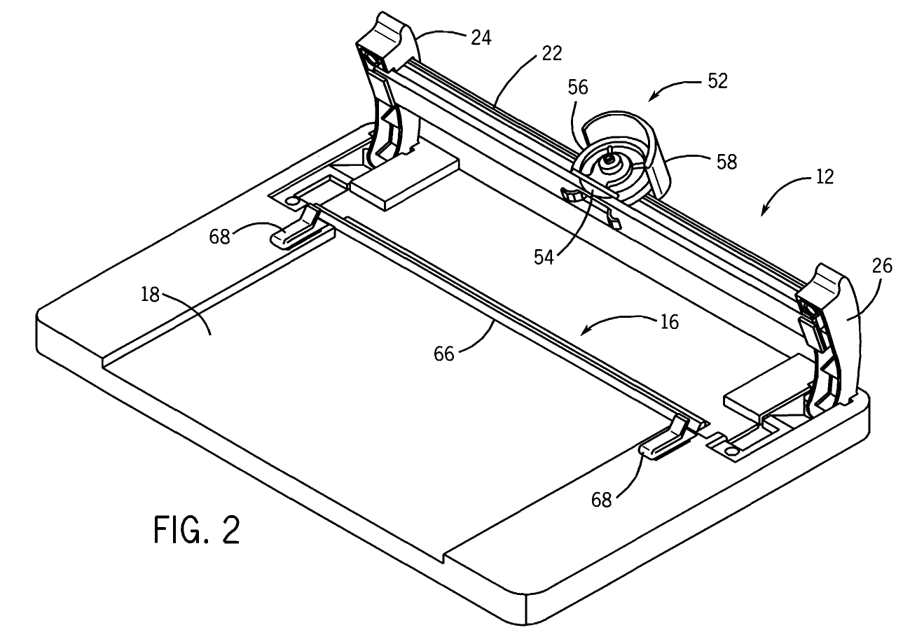

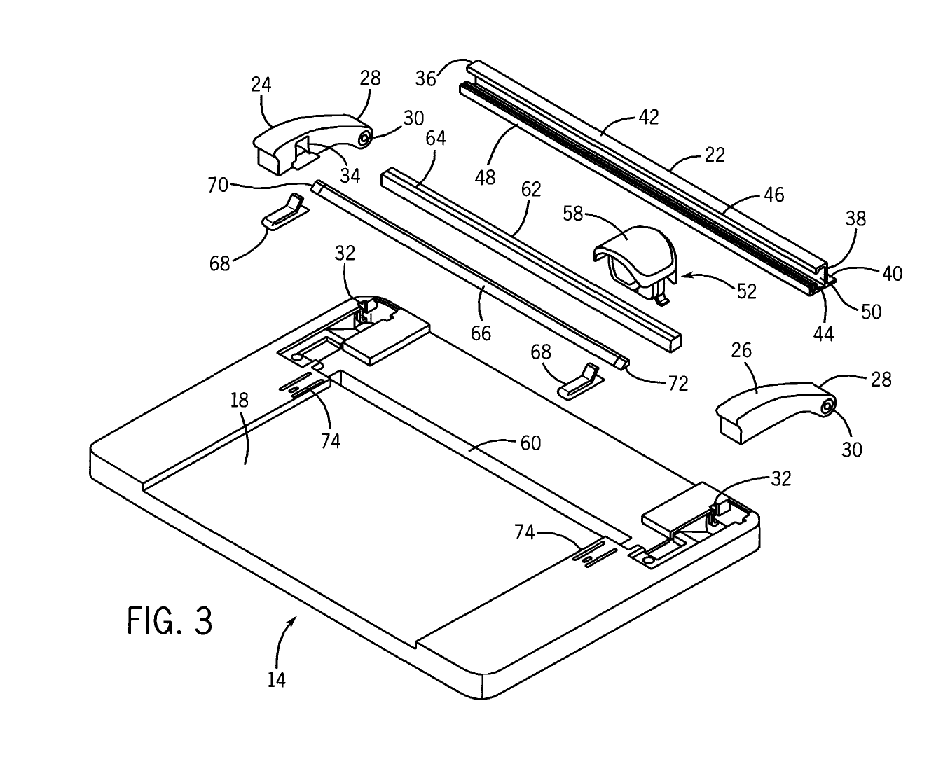

Referring now to FIG. 2, the cutting assembly 12 is shown in its raised, loading position. In this position, sheets of material to be cut can be placed on the support surface 18 in the desired position for cutting. As illustrated in FIG. 2, the cutting assembly 12 includes a support rail 22 mounted between a pair of spaced rail arms 24, 26. As illustrated in FIG. 3, each of the rail arms 24, 26 includes a first end 28 that includes a pair of protruding coupling members 30. The coupling members 30 are received within an associated notch 32 formed in the base 14 such that each of the rail arms 24, 26 are pivotable between the lowered, cutting position shown in FIG. 1 and the raised, loading position shown in FIG. 2.

Referring back to FIG. 3, each of the rail arms 24, 26 includes an open cavity 34 that receives either the first end 36 or the second end 38 of the support rail 22. The support rail 22 includes a back wall 40, a top wall 42, a bottom wall 44, an upper lip 46 and a lower lip 48 that combine to define a slide cavity 50. The slide cavity 50 extends along the entire length of the support rail 22 from the first end 36 to the second end 38.

Referring now to FIG. 2, the support rail 22 receives and supports a rotary trimmer 52 that is freely movable along the length of the support rail 22. The rotary trimmer 52 includes a trimming blade 54 rotatably mounted within a movable trolley 56. The trolley 56 includes a curved, upper gripping surface 58 that allows the user to manually grasp the rotary trimmer 52 and move the rotary trimmer 52 along the length of the support rail 22. As the rotary trimmer 52 is moved along the length of the support rail 22, the trimming blade 54 rotates about a central axis and cuts material positioned beneath the rotary trimmer 52 on the support surface 18.

Referring back to FIG. 3, the base 14 includes a recessed cutting bar cavity 60 that is sized to receive a cutting bar 62. The cutting bar 62 is preferably formed from a plastic material. The cutting bar 62 is generally smooth when installed and the cutting blade forms a blade notch 64 during repeated material cutting. The cutting bar cavity 60 is sized to securely hold the cutting bar 62 such that the cutting bar 62 is generally flush with the generally planar support surface 18 and is repositionable after repeated usage.

As previously discussed with reference to FIG. 1, the material trimmer 10 includes a cut line projector 16. The cut line projector 16 provides a visual indication of the cut line for the cutting assembly 12 on a sheet or sheets of material to be cut when the cutting assembly 12 is in the raised, loading position shown in FIG. 2. The cut line projector 16 provides a visual indicator to the user of the location of the cut line that will be created by the rotary trimmer 52 when the cutting assembly 12 is lowered to its cutting position shown in FIG. 1. Therefore, the cut line projector 16 allows the user to visually review the position of the cut line on the material being trimmed prior to the cutting movement of the trolley 56 along the support rail 22.

In the embodiment shown in FIG. 3, the cut line projector 16 includes a light bar 66 mounted to the base 14 by a pair of light bar mounts 68. The light bar mounts 68 each receive either a first end 70 or a second end 72 of the light bar 66. Both of the light bar mounts 68 are received within mounting slots 74 formed in the base 14. In the position shown in FIG. 2, the light bar 66 is mounted at a projecting angle relative to the generally planar support surface 18 by the pair of spaced light bar mounts 68. The light bar 66 directs an illuminated cut line indicator onto material positioned in the material trimmer 10. Thus, when the cutting assembly 12 is in the raised, loading position shown in FIG. 2 and material to be cut is positioned on the support surface 18, the light bar 66 projects the illuminated cut line indicator onto the material such that the user can determine the cut line before the cutting assembly 12 is lowered into its cutting position.

As illustrated in FIG. 1, the light bar 66 also creates the illuminated cut line indicator when the cutting assembly 12 is in its lowered, cutting position. The illuminated cut line indicator maintains the same position on the material being cut whether the cutting assembly 12 is in its raised, loading position shown in FIG. 2 or is in the lowered, cutting position shown in FIG. 1, since the indicator assembly 16 is securely mounted to the base 14. Thus, before the user exerts a downward force on the gripping section 58 of the rotary trimmer 52, the illuminated cut line indicator created by the cut line projector 16 provides a visual indication to the user as to where the cut line will occur on the material being trimmed.

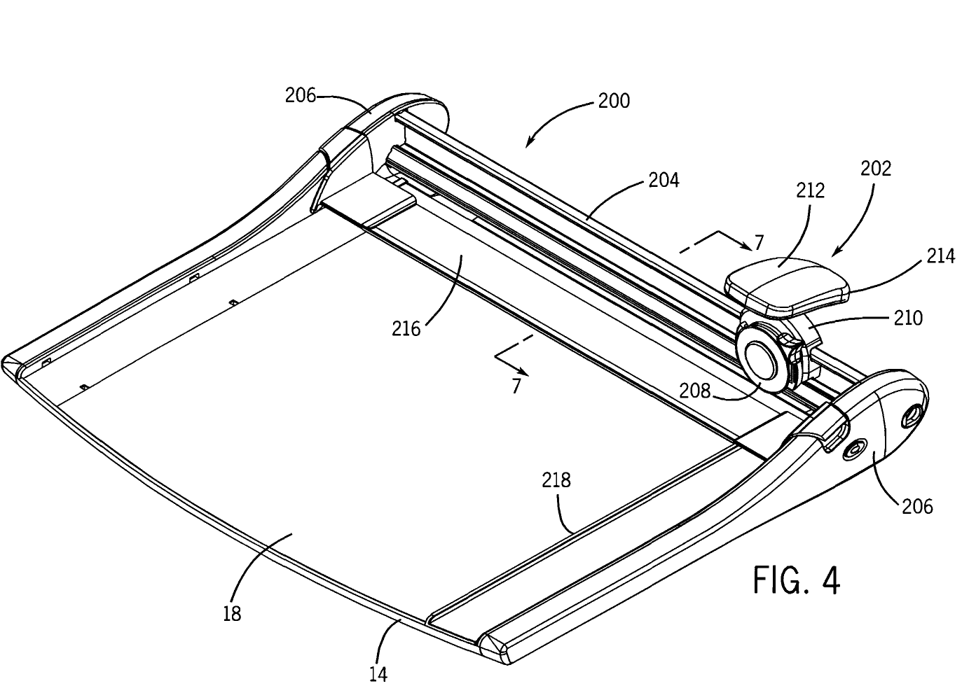

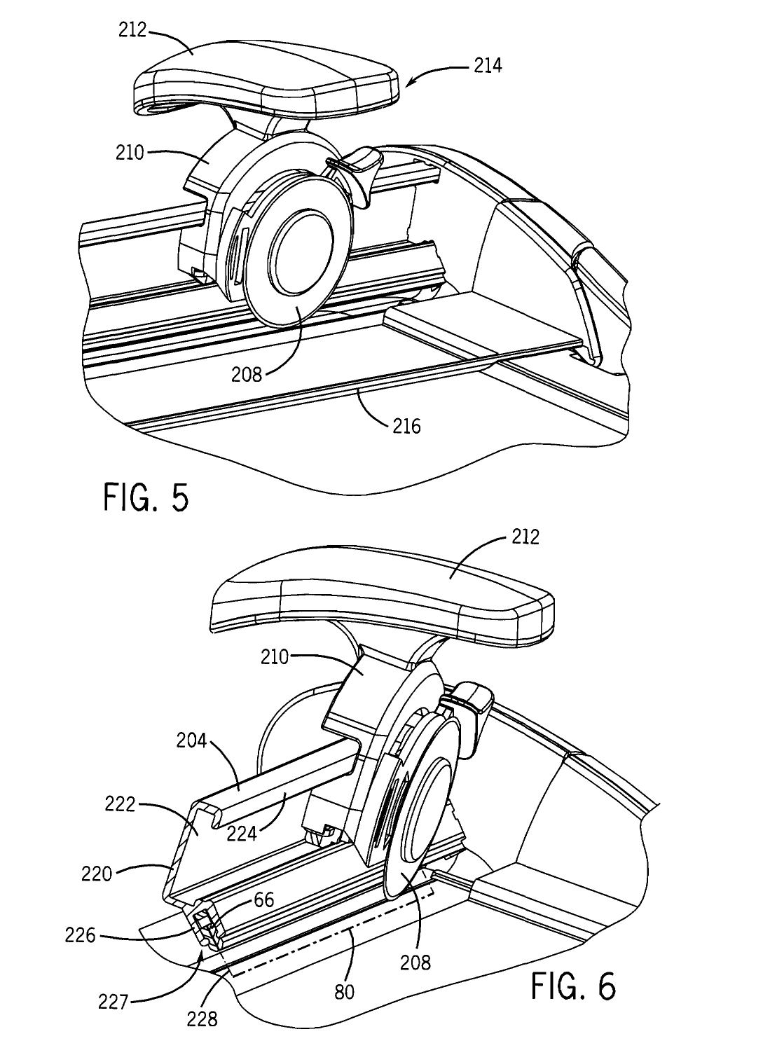

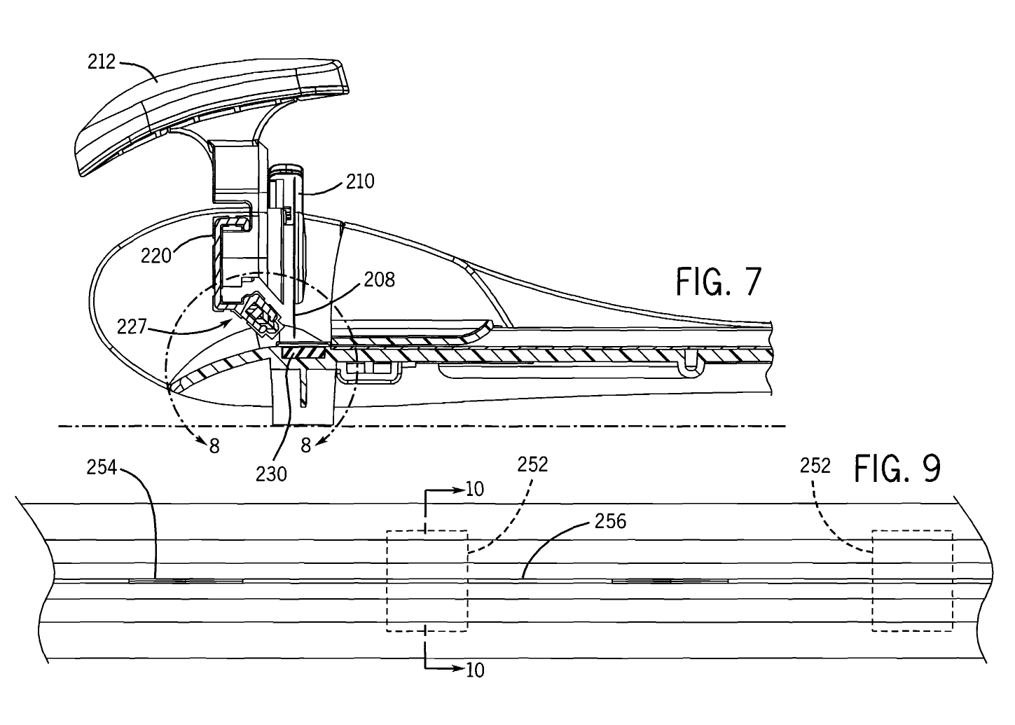

Referring now to FIGS. 4-7, thereshown is a second embodiment of a material trimmer 200. Like the first embodiment shown in FIG. 1, the material trimmer 200 includes a base 14 having a support surface 18 for guiding a piece of material to be trimmed by the material trimmer 200. The material trimmer 200 includes a cutting assembly 202 movable across the width of the material trimmer 200 to cut paper supported along the support surface 18. As illustrated in FIG. 1, the cutting assembly 202 is movable along a support rail 204 mounted between a pair of spaced side arms 206.

The cutting assembly 202 includes a rotating trimming blade 208 that is rotatably mounted within a movable trolley 210. The trolley 210 includes a curved, upper gripping surface 212 that allows the user to grasp the rotary trimmer 214 and move the rotary trimmer 214 along the length of the support rail 204. As the rotary trimmer 214 is moved along the length of the support rail 204, the trimming blade 208 rotates about a central axis and cuts material positioned beneath the rotary trimmer 214 on the support surface 18. In the embodiment show in FIG. 4, the material trimmer 200 includes a protector 216 positioned above the support surface 18. Material being trimmed passes beneath the protector 216 into the area where the material is trimmed by the rotary trimmer 214. In the embodiment illustrated, a paper guide 218 is positioned along the support surface 18 to help guide paper into the cutting area located beneath the rotary trimmer 214.

Referring now to FIG. 6, the trolley 210 is mounted to the support rail 204. The support rail 204 includes a back wall 220 defining an open cavity 222 partially defined by a top lip 224. The lower portion of the support rail 204 includes a U-shaped mounting section 226 that receives and retains the light bar 66. The mounting section 226 and the light bar 66 combine to form the cut line indicator 227 for the material trimmer. The light bar 66 shown in FIG. 6 is similar to the light bar 66 shown in the first embodiment.

As indicated in FIG. 6, the light bar 66 is mounted at an angle relative to the generally vertical back wall 222 and projects a beam of light 228 at an angle relative to vertical. As indicated in FIG. 6, the beam of light 228 creates a cut line indicator 80 in a manner similar to the first embodiment discussed previously.

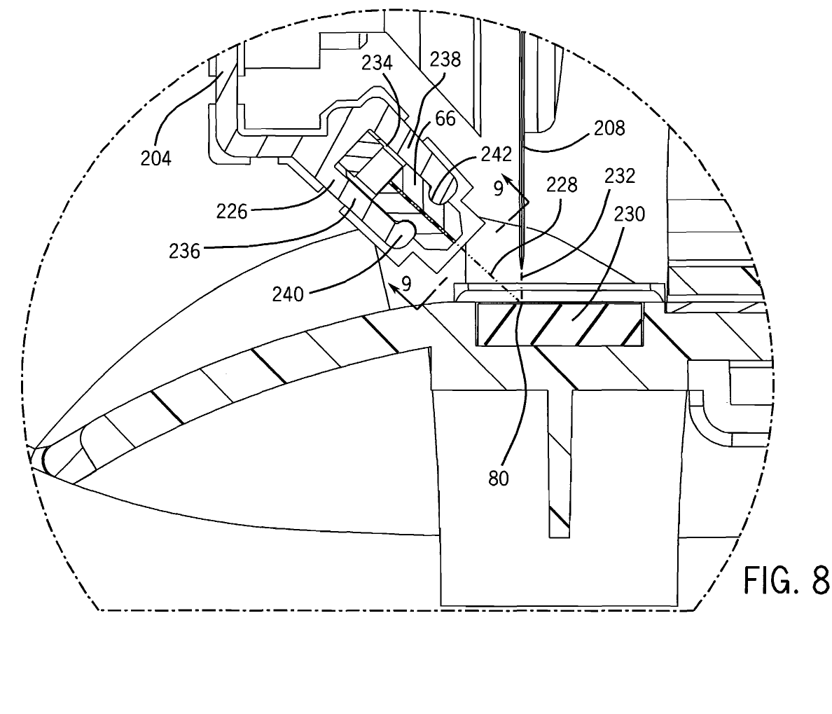

Referring now to FIG. 8, the light beam 228 contacts a cutting bar 230 of the material trimmer at the same location as a vertical line 232 projecting beneath the trimming blade 208. Thus, the illuminated cut line indicator 80 created by the light beam 228 corresponds to the cutting location for the trimming blade 208.

As illustrated in FIG. 8, the mounting section 226 of the support rail 204 defines a receiving cavity 234 that receives the light bar 66. The receiving cavity 234 is defined by a first end wall 236 and a second end wall 238. Both the first end wall 236 and the second end wall 238 include a bulbous end portion 240 that functions to retain the light bar 66 within the receiving cavity 234. In the embodiment illustrated in FIG. 8, the light bar 66 can be slid into the receiving cavity 234 and is prevented from becoming dislodged through the interaction between the end portion 240 and corresponding grooves 242 formed in the light bar 66.

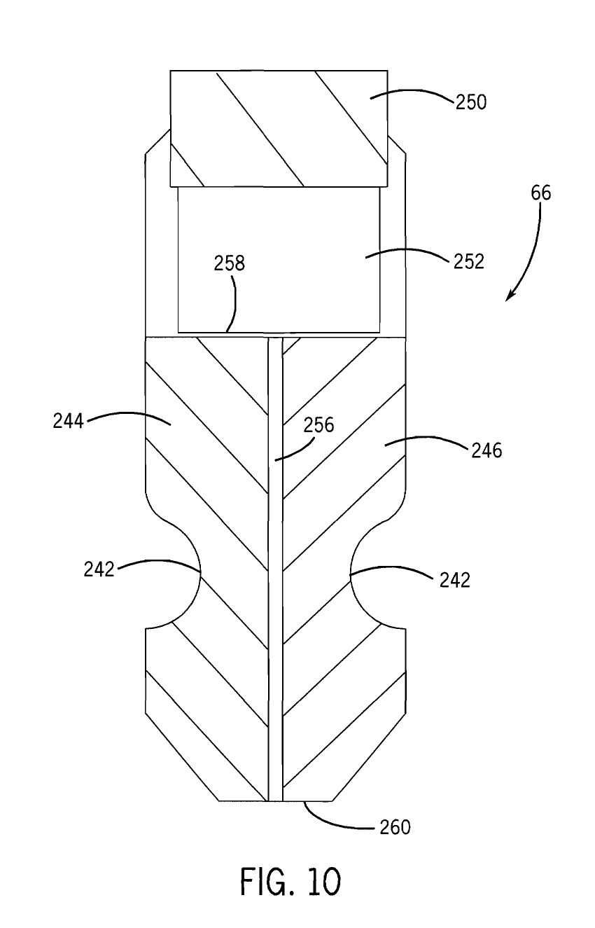

One embodiment of the light bar 66 is illustrated in FIGS. 10-12. Although one embodiment of the light bar 66 is shown in FIGS. 10-12, it should be understood that other embodiments of the light bar 66 could be utilized while operating within the scope of the present disclosure.

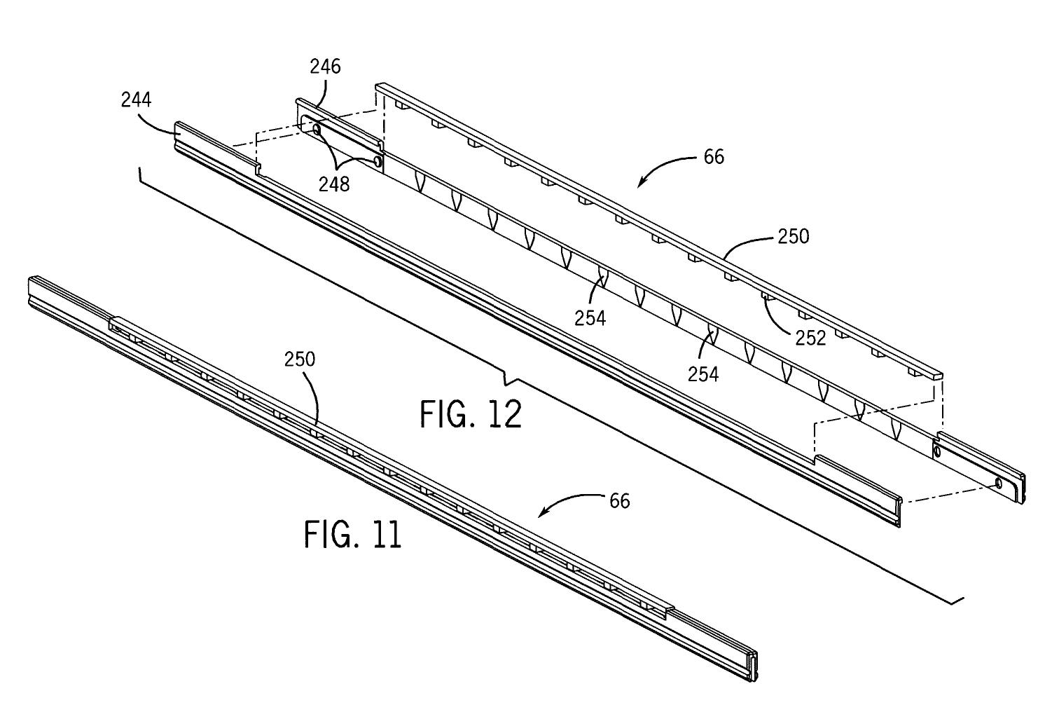

As can best be seen in FIGS. 11 and 12, the light bar 66 is formed from a first lens section 244 and a second lens section 246 joined to each other. In the embodiment illustrated, a series of connector 248 formed on each end of the lens sections 244, 246 help join the lens sections.

The light bar 66 further includes an LED strip 250 mounted to the joined lens section 244, 246. In the embodiment illustrated, the LED strip 250 includes a series of LEDs 252 spaced along the length of the LED strip 50. When the LED strip 250 is mounted to the joined lens sections, the individual LEDs project light through the joined lens sections to create the cut line indicator, as previously described. As illustrated in FIG. 12, each of the lens sections 244, 246 includes V-shaped blocking areas 254 that aid in directing the light from each of the LEDs in the desired direction.

Referring now to FIG. 10, each LED 252 is mounted to the LED strip 250 and oriented in a direction to direct light downward through the pair of spaced first and second lens sections 244, 246. Specifically, light from the LED 252 is directed through an opening 256 formed between the lens sections 244, 246. The opening 256 extends from just below the projecting surface 258 of the LED 252 to the lower end 260. The light beam 228 illustrated in FIG. 8 projects outward from the light bar 266 at the lower end 260. The opening 256 shown in FIG. 10 creates a focus beam of light from the LED 252. The combination of the spaced LEDs 252 creates an illuminated cut line indicator, as previously described.

As illustrated in FIG. 10, both of the first and second lens sections 244, 246 include the recessed groove 242 that helps retain the light bar 66 in the mounting section 226, as previously described.

Referring now to FIG. 9, the individual LEDs 252 are spaced from each other and project light through the opening 256. The V-shaped blocking areas 254 provide separation between the individual LEDs 252 to help focus the light from the LEDs and create the linear cut line indicator.

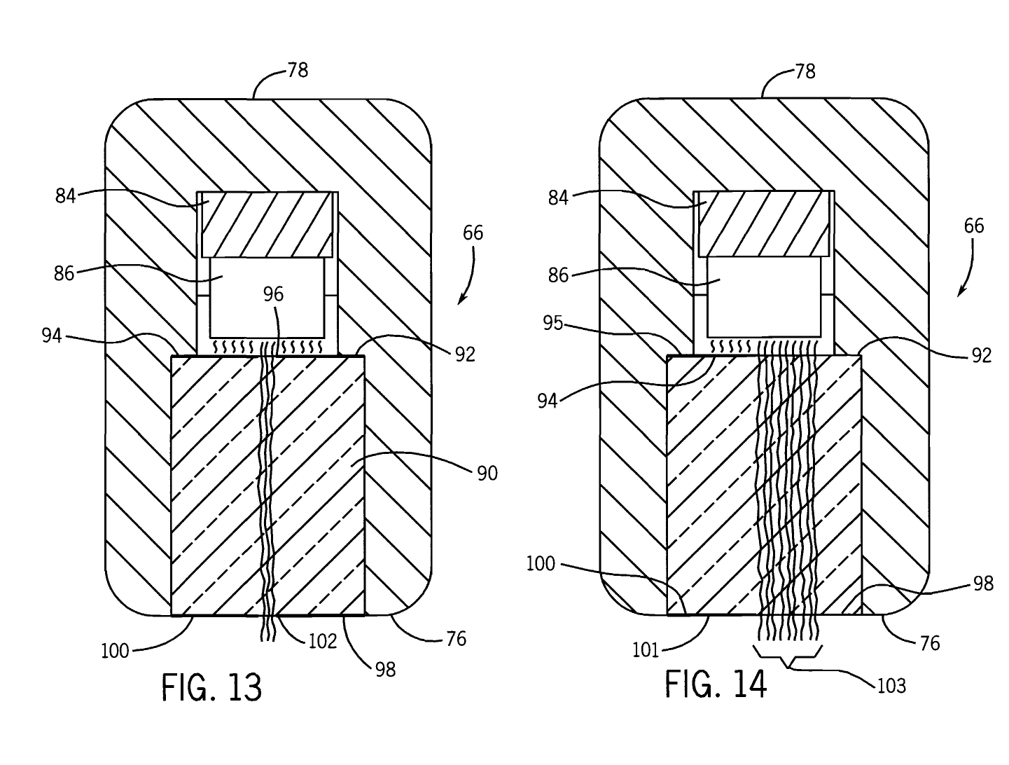

In an alternate embodiment of the light bar 66 shown in FIG. 13, each of the individual LEDs 86 are positioned slightly above a clear acrylic spacer 90. The LEDs 86 each project light in the direction shown in FIG. 13. In the embodiments illustrated in FIG. 13, the top surface 92 of the spacer 90 includes a masking layer 94 that defines a light opening 96. In the embodiment illustrated, the masking layer 94 can be a film applied to the top surface 92 or a printed material also applied to the top surface 92. The masking layer 94 blocks the light emitted from the LED 86 except for in the area defining the light opening 96.

In addition to the masking layer 94, the bottom surface 98 of the spacer 90 also includes a similar masking layer 100. The masking layer 100 also includes a light opening 102 that is generally aligned with the light opening 96. The light opening 102 further focuses the light from the LED 86. Although the sectional view of FIG. 13 illustrates only a single LED 86, it should be understood that the masking layers 94 and 100 extend along the entire length of the spacer 90 to focus the light emitted by the plurality of spaced LEDs 86.

When the light bar 66 is activated, the plurality of individual LEDs 86 each create a source of light that is focused by the pair of masking layers 94, 100 such that the light bar 66 creates the continuous illuminated cut line indicator. However, the light bar 66 may be configured to project a dashed or broken cut line indicator.

As described in the discussion of FIG. 13, the masking layers 94, 100 combine to create a cut line indicator in the form of a continuous line. However, other embodiments are contemplated as being within the scope of the present disclosure. As one example, FIG. 14 illustrates an alternate embodiment of the light bar 66. In the embodiment shown in FIG. 14, the masking layer 94 extends along only the left half 95 of the spacer 90 while the masking layer 100 also only extends over the left half 101 of the spacer 90. As illustrated in FIG. 14, the masking layers 94 and 100 shown in FIG. 14 block one-half of the light emitted by the LED 86. The other half of the light emitted by the LED 86 passes through the spacer 90 to creates an illuminated cut line indicator that creates an illuminated area on the material being cut having the width shown by reference numeral 103 in FIG. 14. Thus, when the embodiment of FIG. 14 is utilized as the light bar 66, the cut line indicator will be the contrasting edge where the light passing through the spacer meets the shadow created by the masking layers 94 and 100.

The location of the illuminated cut line indicator on the material to be cut is dictated by the angle of the light bar 66. In the embodiment shown in FIG. 8, the angled orientation of the light bar 66 projects the cut line indicator 80 into alignment with the cutting blade of the rotary trimmer 214. Thus, a user can determine the location of the cut line on the material positioned within the material trimmer 10 prior to actually cutting the material with the rotary trimmer 214.

In the first two embodiments shown in FIGS. 1-9, the material trimmer is shown including a rotary trimmer that is movable across the support surface. However, it is contemplated that the cut line projector can be utilized with various other types of material trimmers. In other types of material trimmers, the cut line projector operates to project the illuminated cut line indicator onto the sheet material positioned on the support surface to indicate the approximate location of the cut line on the material.

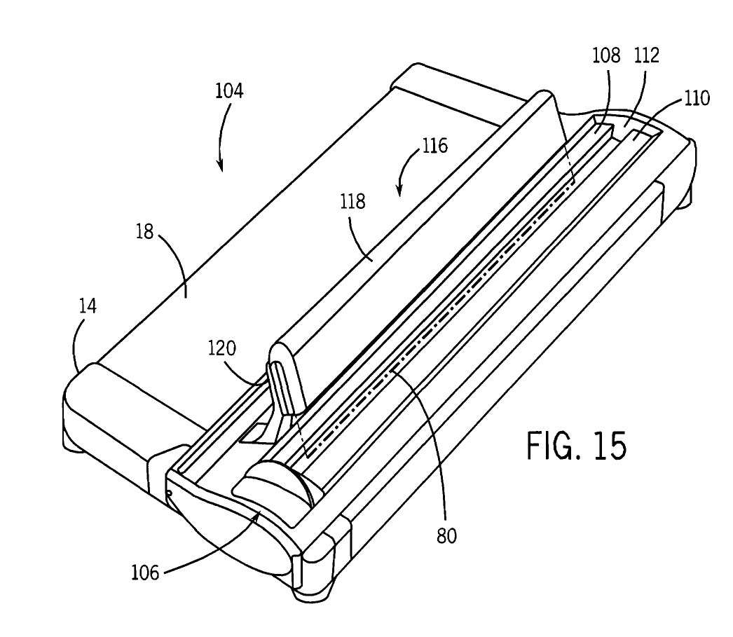

FIG. 15 illustrates a third embodiment of a material trimmer, as indicated by reference numeral 104. In the third embodiment shown in FIG. 15, the material trimmer 104 includes the generally planar support surface 18 formed as part of the base 14. In the embodiment shown in FIG. 15, the material trimmer 104 includes a cutting blade assembly 106 that is movable across the width of the base 14. Specifically, the cutting blade assembly 106 is movable along a pair of rails 108, 110. The rails 108, 110 are spaced to define a blade channel 112. A cutting blade of the cutting blade assembly 106 moves within the blade channel 112 to trim material positioned on the support surface 18.

In the embodiment shown in FIG. 15, the material trimmer 104 includes a cut line projector 116. The cut line projector 116 is similar to the cut line projector 16 shown in FIGS. 1-7. The cut line projector 116 includes a light bar 118 mounted to the base 18 by a pair of light bar mounts 120. The light bar mounts 120 position the light bar 118 at an angle relative to the support surface 18 such that the cut line projector 116 projects the illuminated cut line indicator 80 onto the material being trimmed. As illustrated in FIG. 15, the illuminated cut line indicator 80 is visible to the user prior to movement of the cutting blade assembly 106 across the support surface 18 to trim the material positioned on the support surface 18. In the embodiment shown in FIG. 15, the light bar 118 has a similar configuration to the light bar 66 shown in FIGS. 1-9.

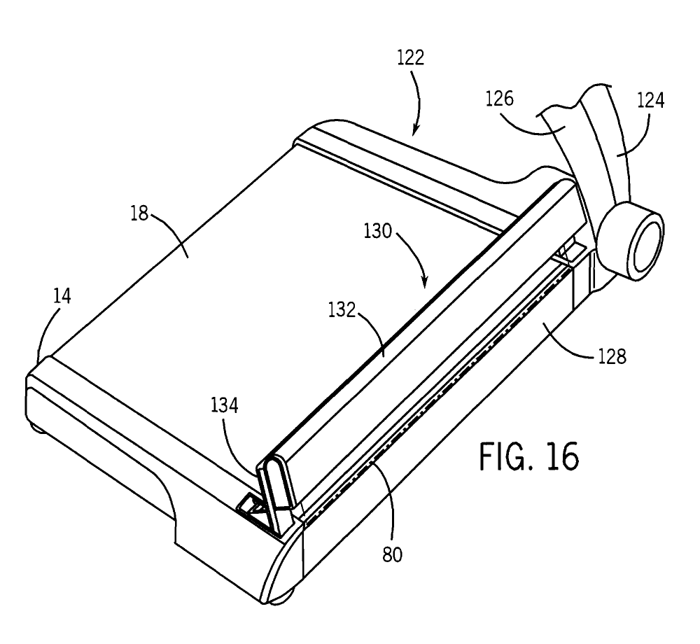

FIG. 16 illustrates a fourth embodiment of a material trimmer 122. The material trimmer 122 includes a base 14 and a generally planar support surface 18. The embodiment of the material trimmer 122 shown in FIG. 16 is referred to as a guillotine trimmer. The material trimmer 122 includes a cutting arm 124 pivotally mounted to the base 14. The cutting arm 124 includes a cutting blade 126 that creates a cutting nip with the edge surface 128.

In the embodiment shown in FIG. 16, the material trimmer 122 includes a cut line projector 130 similar to the cut line projector shown in FIGS. 1-9. The cut line projector 130 includes a light bar 132 mounted to the base by a pair of spaced light bar mounts 134. The light bar mounts 134 position the light bar 132 at an angle relative to the support surface 118 such that the cut line projector 130 creates the illuminated cut line indicator 80 along the material being trimmed. As with the previous embodiment, the illuminated cut line indicator 80 provides a visual indication of the cut line for the cutting blade 126 on the material to be trimmed. The light bar 132 has a similar configuration to the light bar 66 shown in FIGS. 1-9.

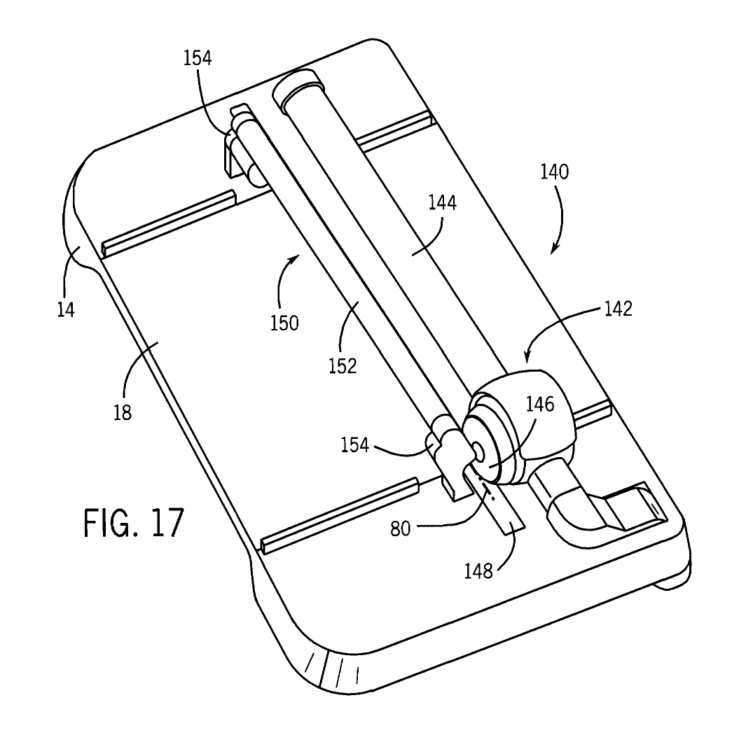

FIG. 17 illustrates yet another embodiment of a material trimmer 140. The material trimmer 140 includes a base 14 having a support surface 18 for supporting material to be trimmed. The material trimmer 140 includes a rotary trimmer 142 that is movable along a support rail 144. The material trimmer 142 includes a trimming blade 146 that contacts a cutting bar 148 mounted within the base 14.

In the embodiment shown in FIG. 17, the material trimmer 140 includes a cut line projector 150. The cut line projector 150 includes a light bar 152 mounted to the base by a pair of spaced light bar mounts 154. The light bar 152 creates the illuminated cut line indicator 80. The cut line indicator 80 is projected onto the material being trimmed such that the user can visually identify the location of the cut line prior to movement of the rotary trimmer 142. The light bar 152 has the same general configuration as the light bar 66 shown in FIGS. 1-9.

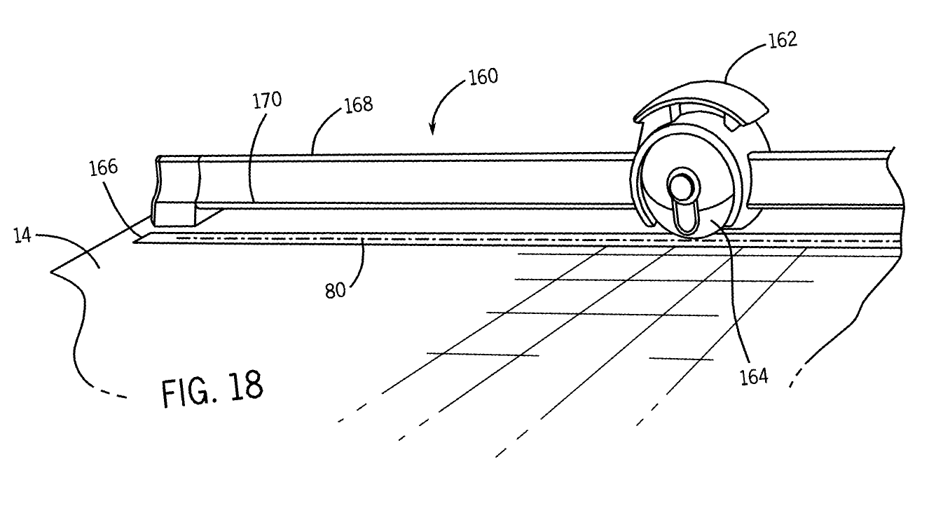

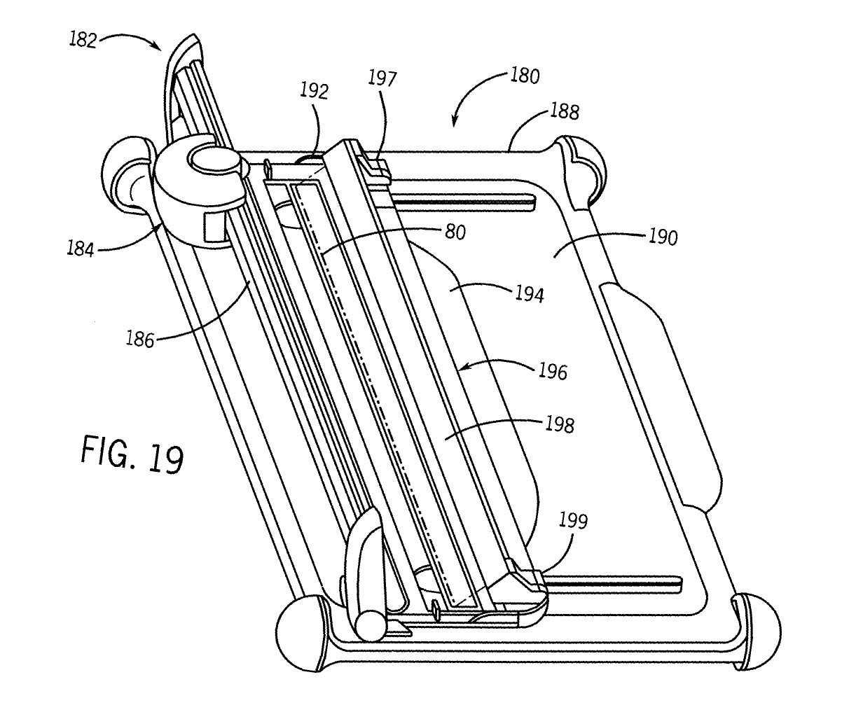

FIG. 18 illustrates yet another embodiment of a material trimmer 160. In the embodiment shown in FIG. 18, the material trimmer 160 includes a rotary trimmer 162 having a trimming blade 164. The trimming blade 164 contacts a cutting bar 166 mounted within the base 14.

As illustrated in the embodiment shown in FIG. 18, the rotary trimmer 162 moves along a support rail 168. In the embodiment shown in FIG. 18, the support rail 168 is integrated with a cut line projector such that the support rail 168 projects the illuminated cut line indicator 80 from the projecting face surface 170. The integrated combination of the cut line projector and support rail 168 includes the similar LED configuration of the light bar, as shown in FIGS. 1-9.

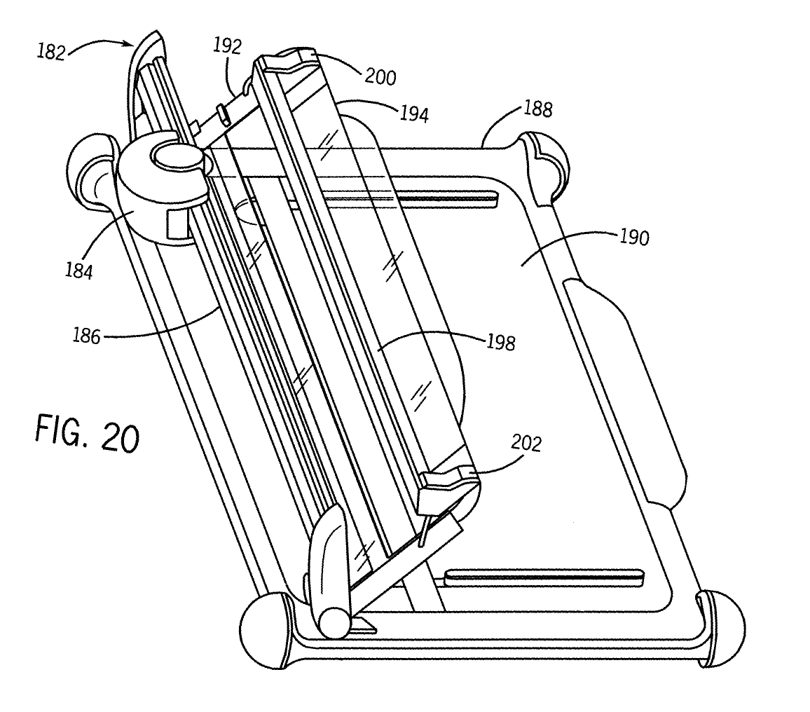

FIGS. 19 and 20 illustrate another embodiment of a material trimmer 180 similar to the material trimmer shown in FIGS. 1-9. The material trimmer 180 includes a cutting assembly 182 that includes a rotary trimmer 184 movable along a support rail 186. The cutting assembly 182 is movable between the raised, loading position shown in FIGS. 19 and 20 and a lowered, cutting position, not shown. The material trimmer 180 includes a base 188 having the generally planar support surface 190 that supports material to be trimmed. In the embodiment shown in FIGS. 19 and 20, the material trimmer 180 includes a protector assembly 192 that protects the material positioned on the support surface 190. Specifically, the protector assembly 192 is movable between the lowered, protecting position shown in FIG. 19 and the raised, loading position shown in FIG. 20. When the protector assembly is in the lowered position of FIG. 19, a clear cover member 194 protects the top surface of the material being trimmed from contact by the user. The clear cover member 194 thus prevents the user from imparting finger prints or other smudges onto the top surface of the material being trimmed. Such embodiment is particularly useful when the material being trimmed includes a decorative surface or is easily smudged, such as with a photograph.

In the embodiment shown in FIGS. 19 and 20, the protector assembly 192 provides a point of attachment for the cut line projector 196. The cut line projector 196 is similar in construction to the cut line projector 16 shown in FIGS. 1-9. The cut line projector 196 includes the light bar 198 mounted to the clear cover member 194 by a pair of light bar mounts 197, 199. As illustrated in FIG. 19, when the protector assembly 192 is in its lowered position, the light bar 198 is positioned at an angle relative to the generally planar support surface 190 such that the light bar 198 can project the illuminated cut line indicator 80 onto the material to be trimmed. In the embodiment illustrated in FIG. 19, the illuminated cut line indicator 80 is a continuous line, although other configurations are contemplated as set forth previously.

Referring now to FIG. 20, when the protector assembly 192 is raised to its loading position, the light bar 198 remains securely attached to the cover member 194 and is raised along with the protector assembly 192. Thus, when material is to be loaded into the material trimmer 180, both the cutting assembly 182 and the protector assembly 192 are raised to the position shown in FIG. 20. Once the material has been positioned on the support surface 190, the protector assembly 192 is lowered such that the cut line projector 196 creates the illuminated cut line indicator 80 on the material to be trimmed.

Embodiments of the present invention may be particularly useful for efficiently and precisely trimming paper materials. However, one skilled in the art will appreciate that the invention is not limited to trimming paper materials but might be employed to cut a variety of relatively thin sheet materials, including fabrics, polymer and rubber type materials, metals and woods. Additionally, it will be appreciated that multiple layers of the same or different materials may be cut simultaneously utilizing the embodiment of the present disclosure.

The foregoing description on the embodiments of the present invention have been presented for purposes of illustration and description. It is not intended to be exhaustive or to limit the present invention to the precise form disclosed, and modifications and variations are possible in light of the above teachings or may be acquired from practice of the present disclosure. The embodiments were chosen and described to explain the principles of the disclosure and its practical application to enable one skilled in the art to utilize the present invention in various embodiments and with various modifications as are suited to a particular use contemplated.

We claim:

1. A material trimmer for trimming sheet material comprising:
a base having a support surface to receive the sheet material;
a blade configure to cut one or more pieces of sheet material oriented on the support surface along a cut line; and
a cut line projector positioned above the support surface of the base, the cut line projector projecting an illuminated cut line indicator onto the sheet material positioned on the support surface to indicate the approximate location of the cut line on the material.

2. The material trimmer of claim 1 further comprising a cutting assembly mounted to the base, the cutting assembly including a rotary trimmer slidingly movable across the support surface of the base to trim the sheet material along the cut line.

3. The material trimmer of claim 1 wherein the projector includes a plurality of light emitting diodes (LEDs) operable to project the illuminated cut line indicator onto the sheet material.

4. The material trimmer of claim 3 wherein the plurality of LEDs are mounted within a light bar, wherein the light bar includes a projecting face surface positioned at an angle relative to the support surface of the base.

5. The material trimmer of claim 4 wherein the light bar is mounted above the support surface of the base such that the sheet material can be moved between the light bar and the support surface.

6. The material trimmer of claim 5 wherein the plurality of LEDs project the illuminated cut line indicator onto the sheet material when the cutting assembly is in a raised, loading position and a lowered, cutting position.

7. The material trimmer of claim 4 wherein the plurality of LEDs are mounted to project light through a spacer, wherein a first surface of the spacer includes a first light opening and a second surface of the spacer includes a second light opening, wherein the first and second light openings create the illuminated cut line indicator.

8. The material trimmer of claim 4 wherein the plurality of LEDs are mounted to project light through an opening between a first lens section and a second lens section to create the illuminated cut line indicator.

9. The material trimmer of claim 4 wherein the illuminated cut line indicator is a continuous line.

10. The material trimmer of claim 4 wherein the cut line indicator is a broken line.

11. The material trimmer of claim 4 wherein the plurality of LEDs are mounted to project light through a spacer, wherein a first surface of the spacer is partially covered to restrict the passage of light and a second surface of the spacer is also partially covered to restrict the passage of light, wherein the illuminated cut line indicator is located at a contrasting edge where the light permitted to pass through the spacer meets the shadow created by the partial surface coverings.

12. A material trimmer for trimming sheets of material, the material trimmer comprising:
a base having a generally planar support surface for receiving the sheet material;
a cutting assembly movable relative to the support surface to cut the sheets of material positioned on the support surface along a cut line; and
a cut line projector positioned above the support surface, the cut line projector projecting an illuminated cut line indicator onto the sheet material when the sheet material is positioned on the support surface, wherein the illuminated cut line indicator indicates the appropriate location of the cut line.

13. The material trimmer of claim 12 wherein the cutting assembly includes a rotary trimmer mounted to a support rail, the rotary trimmer being movable across the support surface to cut the sheets of material positioned on the support surface.

14. The material trimmer of claim 13 wherein the cutting assembly is movable between a raised, loading position and a lowered, cutting position.

15. The material trimmer of claim 14 wherein the rotary trimmer includes a trimming blade that contacts the sheet material along the cut line when the cutting assembly is in its lowered cutting position.

16. The cutting assembly of claim 12 wherein the cut line projector comprises:
a light bar having a plurality of spaced LEDs mounted within a housing having a projecting face surface; and
a pair of light bar mounts each attachable to the base, wherein each of the light bar mounts receives one end of the light bar.

17. The material trimmer of claim 12 wherein the light bar is positioned at an angle relative to the planar support surface.

18. The material trimmer of claim 17 wherein the plurality of LEDs project light through a spacer, wherein the spacer includes a first masking layer and a second masking layer that restrict the light emitted from the spacer.

19. The material trimmer of claim 17 wherein the plurality of LEDs are mounted to project light through an opening between a first lens section and a second lens section to create the illuminated cut line indicator.

20. The material trimmer of claim 11 further comprising a material protector movable between a raised position and a lowered position, wherein the cut line projector is mounted to the material protector and is movable with the material protector between the raised and lowered positions.
